(19) United States
(12) Patent Application Publication
(10) Pub. No.: US 2006/0269742 A1
(43) Pub. Date: Nov. 30, 2006

(54) Apparatus for protecting against impact

(76) Inventors: Stephen F. McDonald, Loganville, GA (US); Michael E. Carroll, Loganville, GA (US)

Correspondence Address: EMERGING STRATEGIES, PLLC, 5440 31ST STREET, N.W., WASHINGTON, DC, 20015-1346, US

(21) Appl. No.: 11/140,049

(22) Filed: May 31, 2005

(51) Int. Cl. B32B 27/10; B32B 27/32

(52) U.S. Cl. 428/342; 428/532; 428/507; 428/513

(57) ABSTRACT

An embodiment configured according to principles of the invention includes a first layer of kraft pulp board bonded on a second layer. The second layer includes a thermally or latex bonded layer of airlaid.

### BACKGROUND OF THE INVENTION

Warehouses and large-scale retail establishments typically have floors consisting of a plurality of concrete slabs, each defining very large areas. In addition to various installations and equipment needed for running the establishment, each establishment typically has many storage and display racks installed or positioned on these floors, or other storage conventions for storing stock and equipment. Initial placement and installation of the storage and other equipment, as well as day-to-day re-stocking, requires transportation equipment. Regardless of the care taken, stock and equipment can fall from the transportation and storage equipment. These falls can cause high impact on the floors, which may result in damage.

Also, as these floors typically are in place prior to erection of the building structure, they are vulnerable to damage during building construction.

While some damage is repairable with localized patching, eventually the patches fail or the damage promotes other failures in the slab. Consequently, damaged slabs must be replaced. Because of the large size of a slab containing damage, replacing a slab can cause significant business interruptions.

Traditionally, the only protection available for floors has been a thin fabric drop cloth or a thin plastic sheet. These may protect against paint or caulking splatters and soil on workers' feet, but do not protect against gouges, scrapes, abrasion, or other damage and breakage due to impact.

Fabric throw rugs or moving-van style blankets could be used to protect floors from impacts. However, these protectors absorb liquids, snag and catch on appliances, and do not protect against sharp and forceful impact. These covers also are bulky and heavy to transport and store.

Other existing floor protectors include a foam sheet bonded to a high-density polymeric film sheet, such as polyethylene or polypropylene. See, for example, U.S. Pat. No. 5,443,885, issued Aug. 22, 1995, to R. D. Wilson for a Floor and Countertop Protector Pad. However, closed cell and membrane covers trap moisture, which is detrimental to desired surface performance after floor finishing and can cause localized discoloration.

What is needed is a temporary cover for floors that provides a rugged, tough, liquid-proof, but vapor permeable, protective barrier that is easily transportable as a compact, lightweight package and easily and quickly installed for use.

### SUMMARY OF THE INVENTION

The invention overcomes the disadvantages noted above by providing a temporary cover for floors that provides a rugged, tough, liquid-proof, but vapor permeable, protective barrier that is easily transportable as a compact, lightweight package and easily and quickly installed for use.

An embodiment configured according to principles of the invention includes a first layer of kraft pulp board bonded on a second layer. The second layer includes a thermally or latex bonded layer of airlaid.

The invention provides improved elements and arrangements thereof, for the purposes described, which are inexpensive, dependable and effective in accomplishing intended purposes of the invention.

Other features and advantages of the invention will become apparent from the following description of the preferred embodiment.

### DETAILED DESCRIPTION OF THE PREFERRED EMBODIMENT

The present cover is ideally suited for protecting concrete floors because it allows curing concrete to breath without entrapping moisture that might cause localized discoloration or reduce serviceability. The invention is ideally suited for freshly cured or “green” concrete as well because it provides protection from spills, impact and abrasion.

The present cover includes a first layer thermally or latex bonded on a second layer. The first layer includes bleached or unbleached Kraft pulp. Preferably, the first layer has a thickness of at least 0.025 inches.

The pulp of the first layer is obtained from a Kraft process, rather than mechanical pulping. Mechanical pulping does not produce a clean product, free of the waxes, resins, silicone, turpentine that are present in the virgin materials recited above. Bleached Kraft pulp provides optimal absorption capabilities by producing clean cellulose. The Kraft process produces a bulkier cellulose with a white absorptive component that prevents discoloration of a concrete surface in contact therewith.

The second layer includes a core of at least polyethylene. A bicomponent layer of polypropylene is disposed on the core. Preferably, the bicomponent layer is airlaid and thermally or latex bonded on the core. Preferably, the second layer also has a thickness of at least 0.025 inches and ranges from 25 GSM to 500 GSM.

As used herein, “airlaid” refers to a fibrous structure formed primarily by a process involving deposition of air-entrained fibers onto a mat, typically with binder fibers, and typically followed by densification and thermal bonding. In addition to traditional thermally bonded airlaid structures, those formed with non-tacky binder material and substantial thermally bonded, “airlaid,” according to the present invention, also includes co-form, which is produced by combining air-entrained dry, dispersed cellulosic fibers with meltblown synthetic polymer fibers while the polymer fibers are still tacky.

“Airlaid” also includes an airformed web to which binder material is added subsequently. Binder may be added to an airformed web in liquid form, e.g., an aqueous solution or a melt, by spray nozzles, direction injection or impregnation, vacuum drawing, foam impregnation, and so forth. Solid binder particles also may be added by mechanical or pneumatic means.

Bi-component and multibond fibers are coaxial fibers having an inner component with a higher melting temperature than an encasing outer component. When heated, the outer component melts for bonding with other elements, while the inner component does not melt, thus lending integrity and strength to the bonded material. The inner and outer components may be selected from polypropylene, polyethylene or other compositions suitable for the purposes described.

The present cover also may include a sufficient amount of ethylene vinyl acetate to reduce dusting during manufacture and promote integrity during use.

A latex bonding agent may be sprayed on the natural fibers obtained from the Kraft processing, or may be integrated in the bi-component or multibond fibers. The latex binding agent aids in strengthening the adhesion among the bi-component or multibond fibers and other materials.

The first and second layers are designed to present differential absorption properties to trap liquid in the top surface of the first layer. This discourages liquid from pooling on the surface of a curing slab, which might cause localized discoloration.

The invention is not limited to the particular embodiment(s) described and depicted herein, rather only to the following claims.

We claim:

1. Apparatus for protecting against impact comprising:
a first layer comprising kraft pulp board; and
a second layer, comprising thermally or latex bonded airlaid, on said first layer.

2. Apparatus of claim 1, wherein said second layer comprises:
a core comprising polyethylene; and
a bicomponent layer of polypropylene on said core.

3. Apparatus of claim 1, wherein said first layer is bleached or unbleached.

4. Apparatus of claim 1, wherein said first layer has a thickness of at least 0.025 inches.

5. Apparatus of claim 1, wherein said first layer and said second layer are configured to provide differential absorption such that moisture tends to adsorb into said first layer more than into said second layer.

6. Apparatus of claim 1, wherein said second layer is airlaid.

7. Apparatus of claim 1, wherein said second layer has a thickness of at least 0.025 inches.

8. Apparatus of claim 1, wherein said second layer is 25 GSM to 500 GSM.

9. Apparatus of claim 1, wherein said apparatus is permeable to vapor moisture.

10. Apparatus of claim 1, wherein said apparatus is biodegradeable.
